(19) United States
(12) Patent Application Publication
(10) Pub. No.: US 2017/0067596 A1
(43) Pub. Date: Mar. 9, 2017

(54) SUPPORTING SPACER

(71) Applicant: PINGOOD ENTERPRISE CO., LTD., Taipei (TW)

(72) Inventor: MAU-SHEN LIN, TAIPEI (TW)

(21) Appl. No.: 14/881,958

(22) Filed: Oct. 13, 2015

(30) Foreign Application Priority Data
Sep. 3, 2015 (TW) 104214317

(51) Int. Cl. F16M 13/02; F16B 2/22

(52) U.S. Cl. CPC F16M 13/022; F16B 2/22

(57) ABSTRACT

A supporting spacer includes a vertical pole, a combining portion and an abutting portion. The combining portion includes a base connecting with the vertical pole and a pair of resilient hooks reverse extended from an end of the base, and a spaced slot is formed correspondingly between the base and each resilient hook. The abutting portion includes a pair of arms outward extended from the base. Thus the supporting spacer can prevent shaking of the supporting spacer and enhance the stability of structures after being fixed.

### BACKGROUND OF THE INVENTION

Field of the Invention

The present invention generally relates to a supporting spacer, in particular to a supporting spacer applied to a liquid crystal display.

Description of Prior Art

After the manufacturing of LCD monitors and LCD TVs are completed, packaging and shipping are usually needed for delivering them to users. However, shakings of LCD monitors are more or less occurred due to bumpy roads or careless operation of transporting personnel during transportation. Because a glass layer is usually disposed in an outer side of LCD monitor, the shakings will result in ruptures by a large curvature of the glass layer. In order to solve the aforementioned problems, plural of supporting spacers are provided on the metal plates behind the LCD monitors.

A conventional supporting spacer mainly includes a vertical pole and an insert socket, the insert socket is extended from the bottom of the vertical pole and has resilient hooks extended from the bottom of the insert socket. Therefore LCD monitors can be avoided from broken by using resilient hooks combining to the metal plates.

However, conventional supporting spacers still have following problems in use. As the vertical pole is not placed firmly, the bending and deformation of the LCD monitors make the vertical pole become tilted that will provide a poor supporting and prevention effects.

In view of the above drawbacks, the Inventor proposes the present invention based on his expert knowledge and elaborate researches in order to solve the problems of prior art.

### SUMMARY OF THE INVENTION

Accordingly, an object of the present invention is to provide a supporting spacer which can prevent shaking of the supporting spacer and enhance the stability of structures after being fixed.

In order to achieve the object mentioned above, the present invention provides a supporting spacer including a vertical pole, a combining portion and an abutting portion. The combining portion includes a base connecting with the vertical pole and a pair of resilient hooks reverse extended from an end of the base, and a spaced slot is formed correspondingly between the base and each resilient hook. The abutting portion includes a pair of arms outward extended from the base.

The present invention has the following effects. The vertical pole is made of transparent material that dark spots shown on the LCD monitor can be avoided. Besides, the resilient hook has a trough and a groove that are provided for easy installation, and an elastic deformation of the resilient hook can be improved for the feasibility of the installation. Furthermore, the stability of a left-and-right orientation of the supporting spacer can be held by the deposition of the upward ribs and the pressing rib.

### BRIEF DESCRIPTION OF DRAWING

The features of the invention believed to be novel are set forth with particularity in the appended claims. The invention itself, however, may be best understood by reference to the following detailed description of the invention, which describes a number of exemplary embodiments of the invention, taken in conjunction with the accompanying drawings, in which:

FIG. 1 is a perspective schematic view of the first embodiment of the present invention;

FIG. 2 is another view of FIG. 1;

FIG. 3 is a front view of the first embodiment of the present invention combining with a metal plate;

FIG. 4 is an operating schematic view of the first embodiment of the present invention applied in an LED screen;

FIG. 5 is a perspective schematic view of the second embodiment of the present invention;

FIG. 6 is another view of FIG. 5;

FIG. 7 is a partial sectional view of the second embodiment of the present invention;

FIG. 8 is an operating schematic view of the second embodiment of the present invention applied in an LED screen;

FIG. 9 is another sectional view of the second embodiment of the present invention applied in an LED screen;

FIG. 10 is a perspective schematic view of the third embodiment of the present invention;

FIG. 11 is a perspective schematic view of the fourth embodiment of the present invention; and

FIG. 12 is a partial sectional view of the fourth embodiment of the present invention.

### DETAILED DESCRIPTION OF THE PREFERRED EMBODIMENTS

In cooperation with attached drawings, the technical contents and detailed description of the invention are described thereinafter according to a number of preferable embodiments, being not used to limit its executing scope. Any equivalent variation and modification made according to appended claims is all covered by the claims claimed by the present invention.

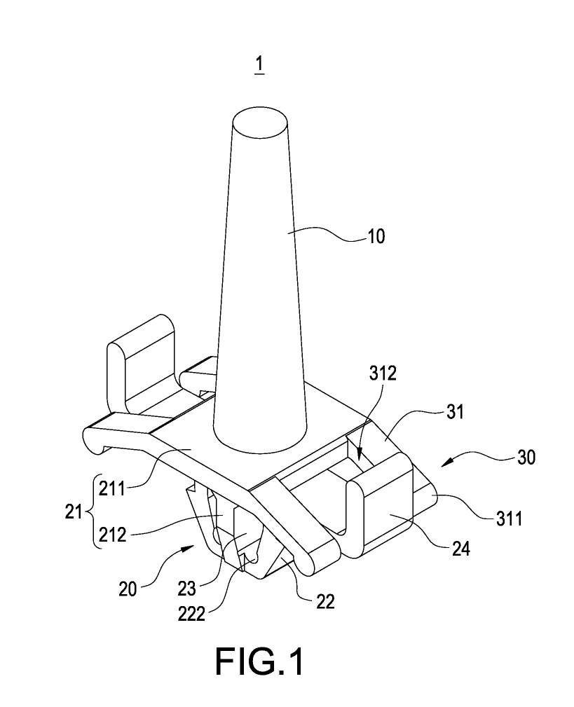

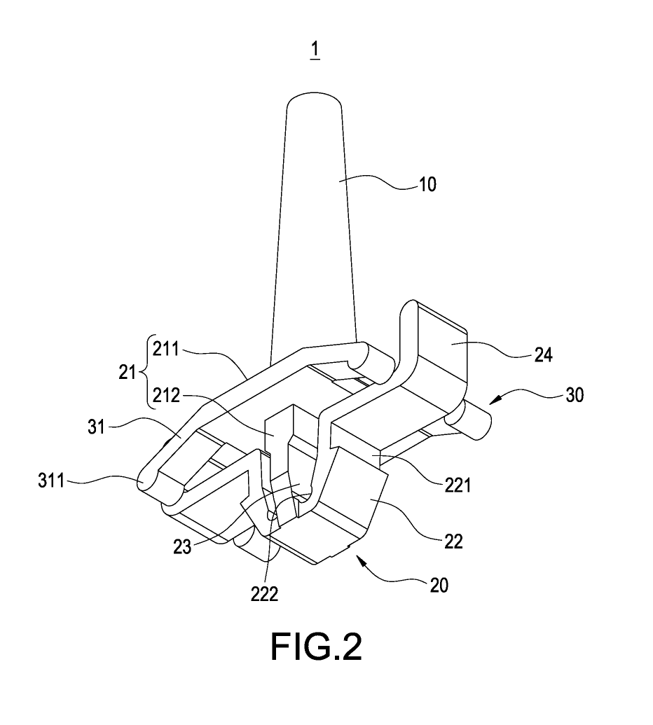

Please refer to FIG. 1 and FIG. 2, the present invention provides a supporting spacer 1, and the supporting spacer 1 mainly includes a vertical pole 10, a combining portion 20 and an abutting portion 30.

In the present invention, the vertical pole 10 is a cone which has a diameter of an upper end smaller than a diameter of a lower end, and the vertical pole 10 can be made of translucent material.

The combining portion 20 can be made of an opaque material. The combining portion 20 includes a base 21 and a pair of resilient hooks 22. The base 21 substantially configured in T-shaped includes a seat plate 211 and a vertical plate 212 extending from the seat plate 211 in a direction away from the vertical pole 10. The seat plate 211 is connected in a bottom of the vertical pole 10. Each resilient hook 22 is reverse bent from a bottom of the vertical plate 212, and a spaced slot 23 is formed correspondingly between the the vertical plate 212 and each of the resilient hooks 22. Besides, each resilient hook 22 has a handle 24 provided in an end away from the vertical plate 212.

There is a trough 221 in an outer corner of each resilient hook 22. Furthermore, the resilient hook 22 has a groove 222 in an inner side of the spaced slot 23 connecting with the vertical plate 212. Therefore, an elastic deformation of the resilient hook 22 can be improved for the feasibility of installation.

The abutting portion 30 includes a pair of arms 31. Each arm 31 is tilt down and outward extended from the base 21 to a place where the resilient hook 22 and the handle 24 are joined, and the arm 31 has a contacting rib 311 formed at an end away from the seat plate 211. The arm 31 is substantially configured in a flat-bottomed U shape and has a notch 312. The notch 312 is provided for accommodating an end of the resilient hook 22 and for the handle 24 to outstretch upwardly.

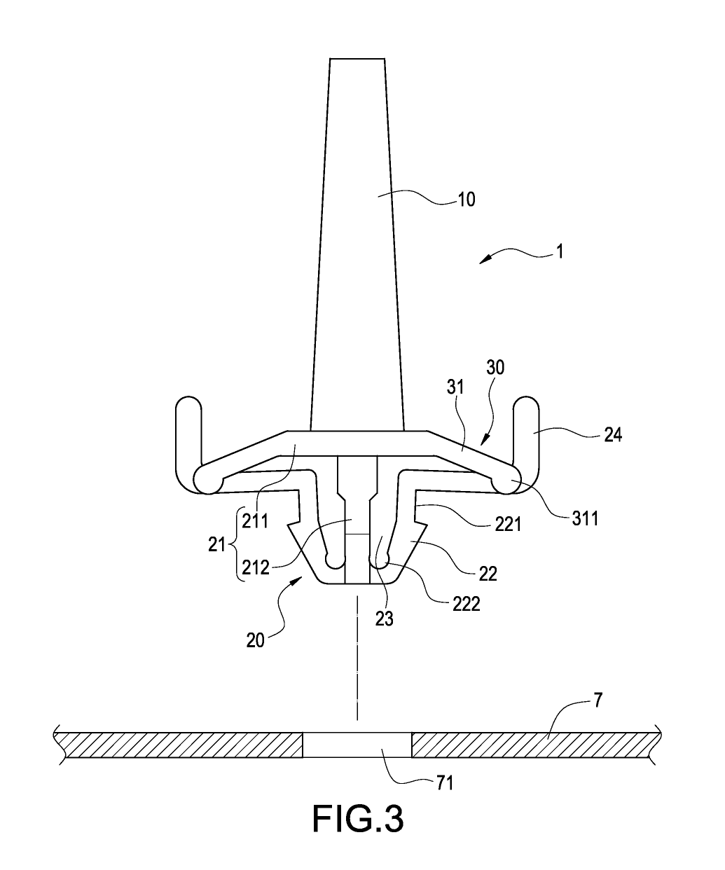

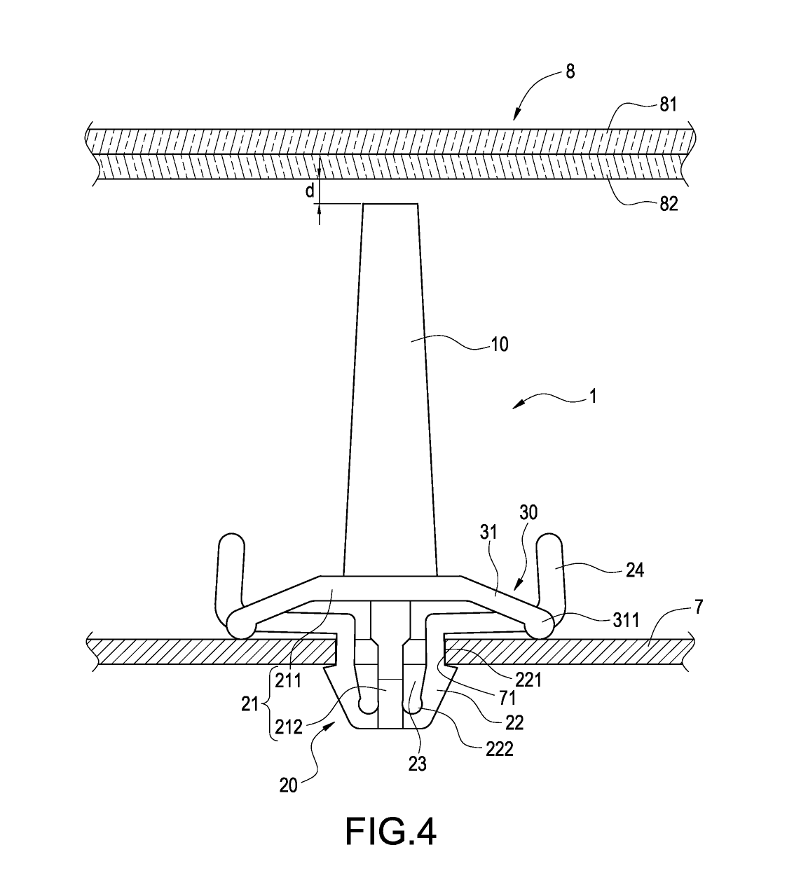

Please refer to FIG. 3 and FIG. 4, wherein the FIG. 3 shows a supporting spacer 1 installed in a metal plate 7. The metal plate 7 is provided with a through hole 71, and the combining portion 20 is inserted in the through hole 71. In FIG. 4, the supporting spacer 1 and the metal plate 7 are combined and applied in a LCD monitor 8. The LCD monitor 8 comprises a glass plate 81 and a light guide plate 82 which are stacked. As the LCD monitor 8 in its periphery is supported by a frame (not shown), the aforementioned combination structures are placed in a back of the LCD monitor 8 that an interval d is formed between the top of the vertical pole 10 and the light guide plate 82. When the LCD monitor 8 is in the process of moving, the LCD monitor 8 may get bent because of vibration or other factors. Thus the resilient hook 22 will be elastically deformed by a pushing of the inner wall of the through hole 71, and the trough 221 will be retained in the through hole 71. Then the arm 31 is pressed with the contacting rib 311 on an upper surface of the metal plate 7 thus the supporting spacer 1 can be fixed firmly on the metal plate 7. In this way, ruptures of the glasses 81 of the LCD monitor 8 can be avoided from excessive deformation.

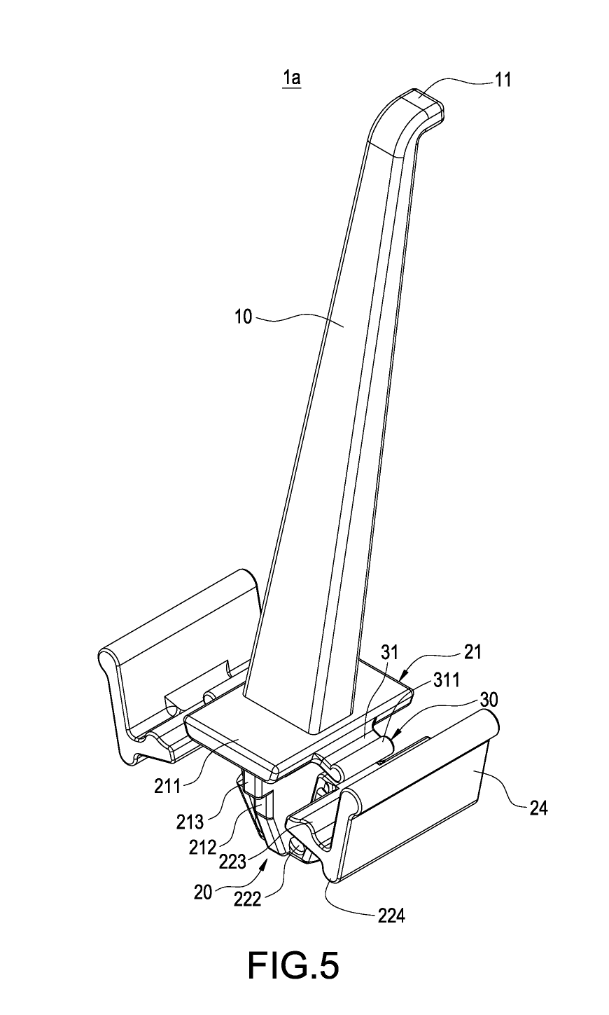

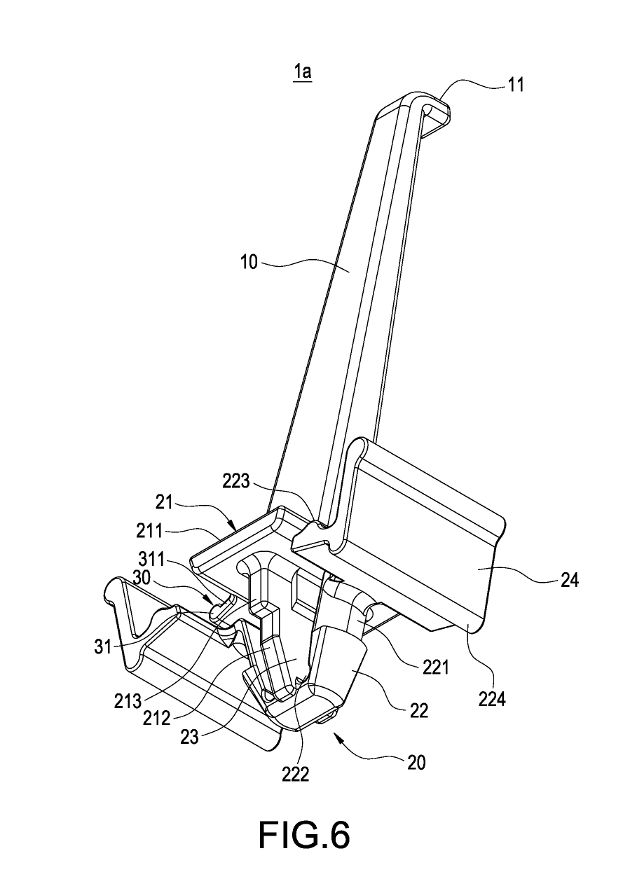

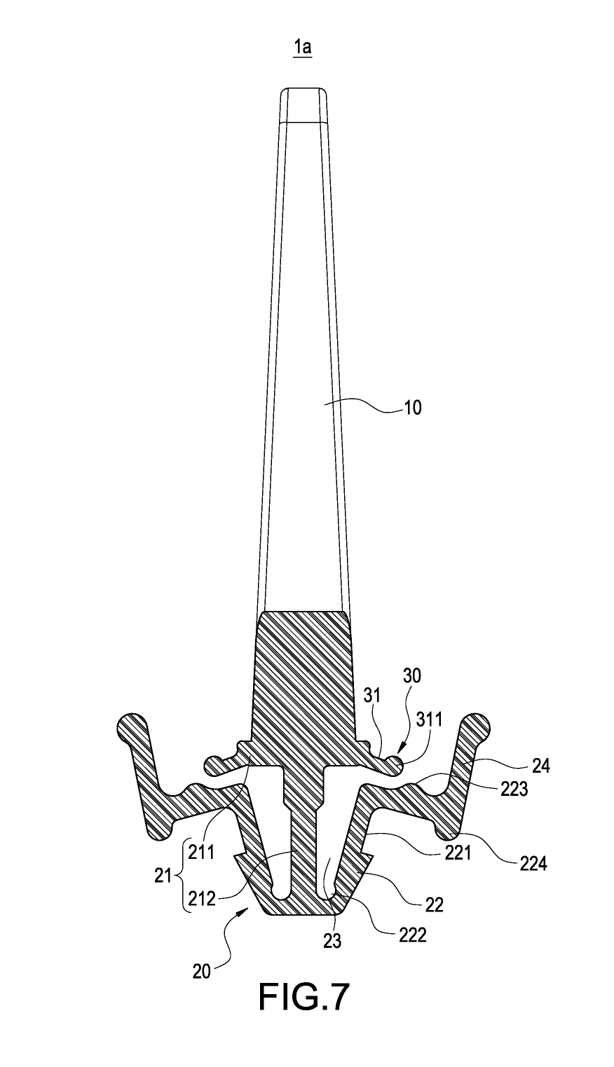

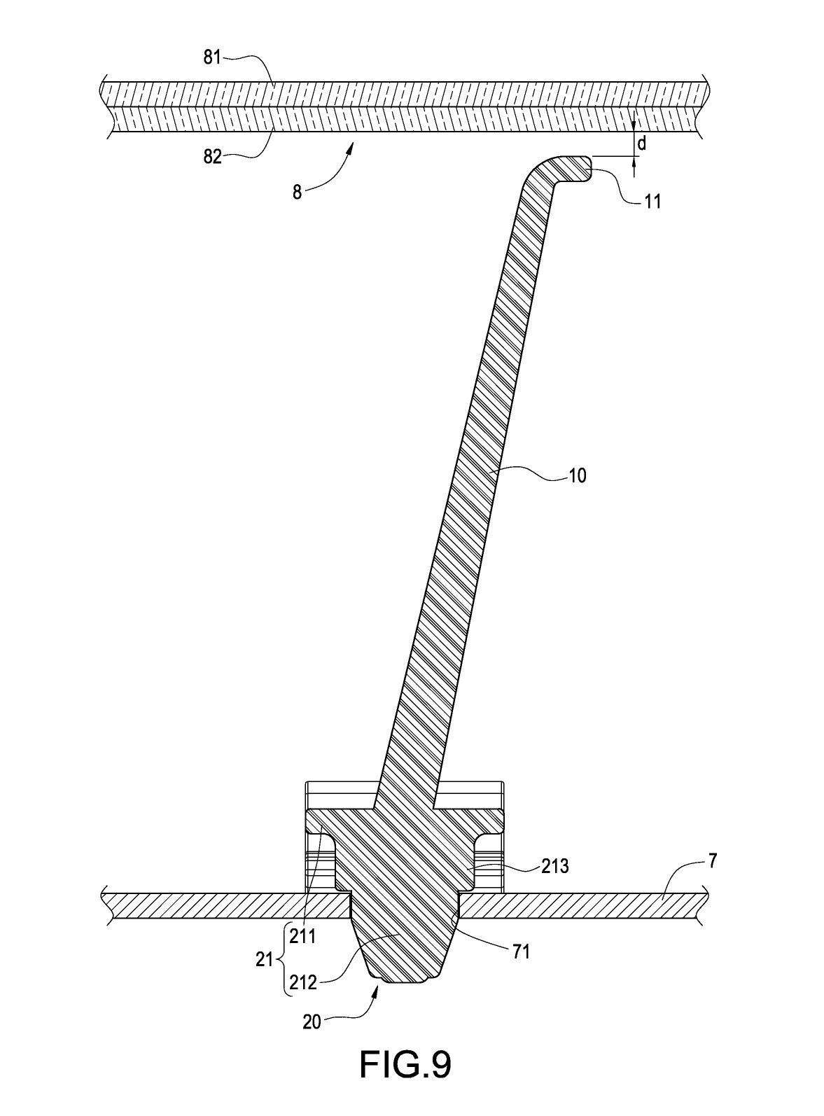

Please refer to FIG. 5 to FIG. 9, a supporting spacer 1a in the present embodiment differs from the supporting spacer 1 of the first embodiment in that a cross section of the vertical pole 10 is a quadrilateral and formed in a tilt upward manner, and a bent section 11 is formed in the top of the vertical pole 10. Moreover, the vertical plate 212 has a step section 213 formed neighboring the seat plate 211, and the bottom of the step section 213 abuts the upper surface of the metal plate 7. Thereby, the stability in a longitudinal direction of the supporting spacer 1a will be controlled (shown in FIG. 9).

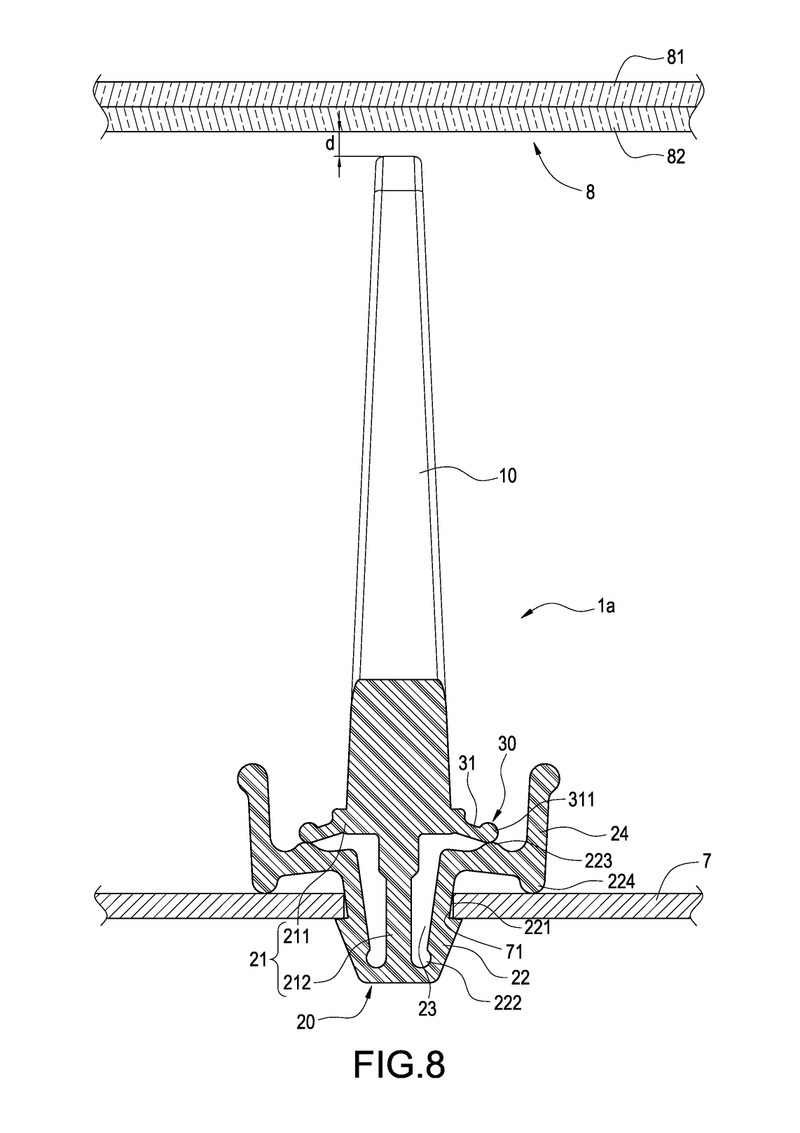

Further, the resilient hook 22 has an upward rib 223 and a pressing rib 224 formed neighboring the handle 24, and the upward rib 223 is provided corresponding to the contacting rib 311. When the combining portion 20 is inserted in the through hole 71 of the metal plate 7, the contacting rib 311 is pressed on the upward rib 223 and the pressing rib 224 is pressed on the upper surface of the metal plate 7 and thus the supporting spacer 1 can be fixed firmly on the metal plate 7. Thereby, the stability in a left-and-right (transverse) direction of the supporting spacer 1a can be controlled (as shown in FIG. 8).

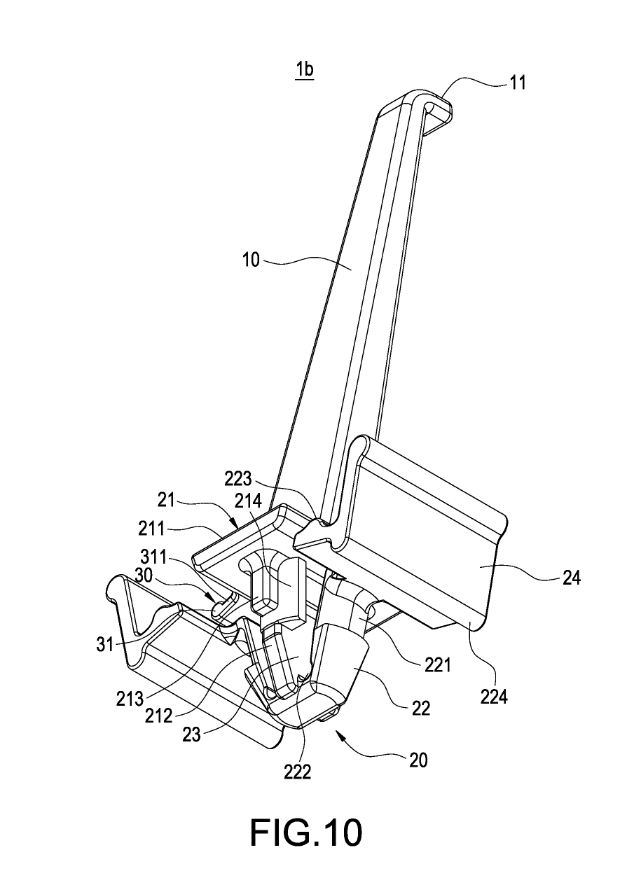

With referring to FIG. 10, a supporting spacer 1b in the present embodiment differs from the supporting spacer 1 of the first embodiment in that the vertical plate 212 has a platform 214 formed in a lateral side of the step section 213. When the resilient hook 22 is pushed in the through hole 71 of the metal plate 7, an inner lateral side of the platform 214 will against the lateral side of the resilient hook 22 for forming a stable holding structure.

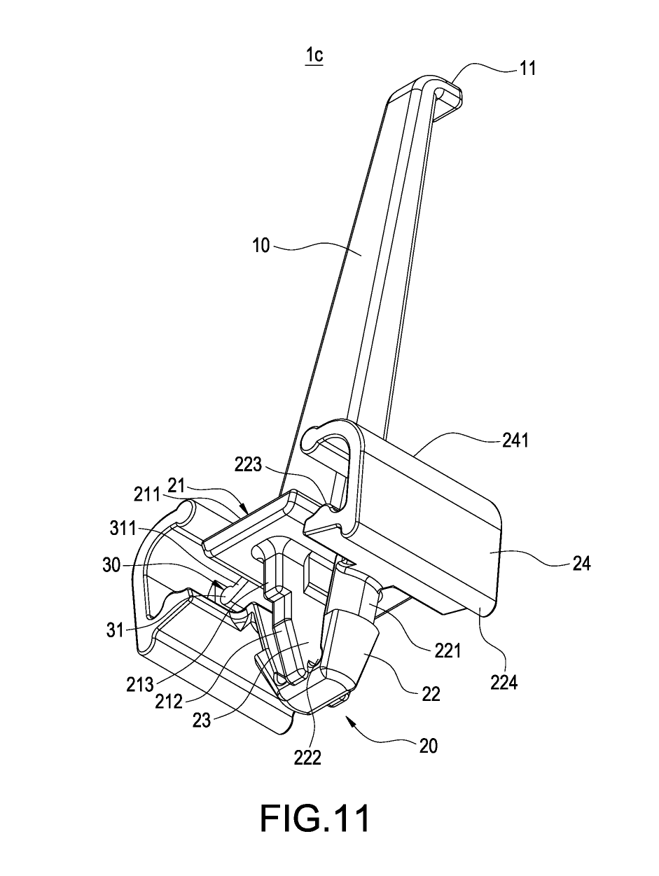

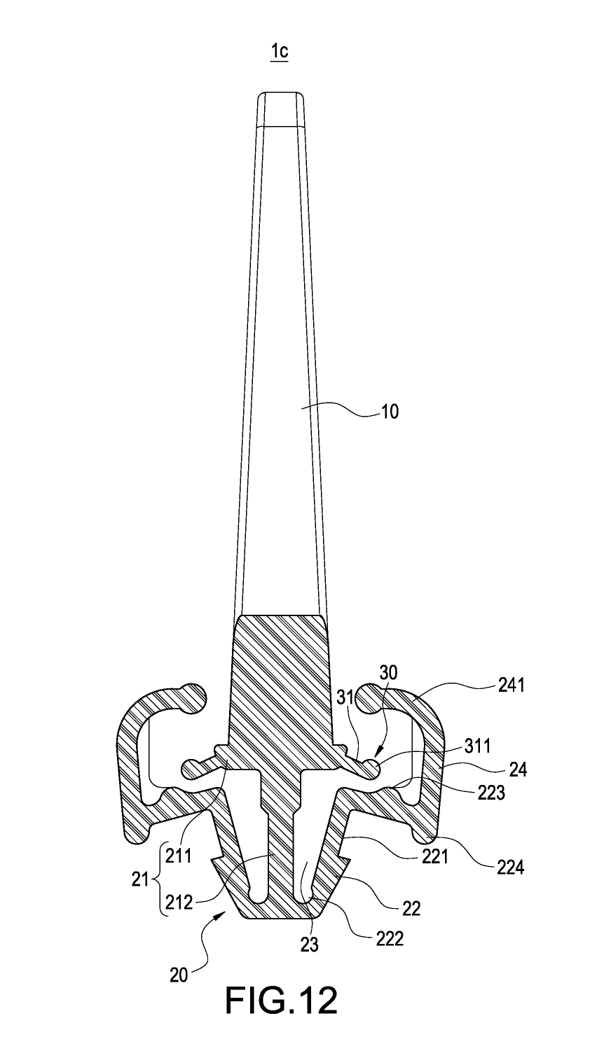

Please refer to FIG. 11 and FIG. 12, a supporting spacer 1c in the present embodiment differs from the supporting spacer 1 of the first embodiment in that an end of the handle 24 has a bent portion 241 inward extended and implemented in different fields.

In summary, the supporting spacer of the present invention can achieve the expected objective and overcome the disadvantages of the prior art. Also it is indeed novel, useful, and non-obvious to be patentable. Please examine the application carefully and grant it as a formal patent for protecting the rights of the inventor.

What is claimed is:

1. A supporting spacer, comprising:
a vertical pole (10);
a combining portion (20) including a base (21) connecting with the vertical pole (10) and a pair of resilient hooks (22) reverse extended from an end of the base (21), and a spaced slot (23) formed correspondingly between the base (21) and each resilient hook (22); and
an abutting portion (30) including a pair of arms (31) outward extended from the base (21).

2. The supporting spacer according to claim 1, wherein the base (21) is configured in T-shaped, and the base (21) includes a seat plate (211) and a vertical plate (212) extended from the seat plate (211) and in a direction away from the vertical pole (10), the seat plate (211) is connected in a bottom of the vertical pole (10), each resilient hook (22) is reverse bent from a bottom of the vertical plate (212), and each of the spaced slots (23) is formed between the vertical plate (212) and the resilient hook (22) separately.

3. The supporting spacer according to claim 2, wherein the resilient hook (22) has a handle (24) provided in an end away from the vertical plate (212).

4. The supporting spacer according to claim 3, wherein the arm (31) is configured in a flat-bottomed U shape and has a notch (312), the notch (312) is provided for accommodating an end of the resilient hook (22) and for the handle (24) to outstretch upwardly.

5. The supporting spacer according to claim 4, wherein the arm (31) is tilt down and extended from the seat plate (211), the arm (31) has a contacting rib (311) formed at an end away from the seat plate (211), and the contacting rib (311) is extended to a place where the resilient hook (22) and the handle (24) are joined.

6. The supporting spacer according to claim 3, wherein the resilient hook (22) has an upward rib (223) formed neighboring the handle (24), the arm (31) has a contacting rib (311) formed at an end away from the seat plate (211), and the upward rib (223) is provided corresponding to the contacting rib (311).

7. The supporting spacer according to claim 6, wherein an end of the handle (24) has a bent portion (241) inward extended, and a pressing rib (224) is formed at an outer side of where the resilient hook (22) and the handle (24) are joined.

8. The supporting spacer according to claim 2, wherein the arm (31) has a contacting rib (311) formed at an end away from the seat plate (211).

9. The supporting spacer according to claim 2, wherein the vertical plate (212) has a step section (213) formed neighboring the seat plate (211).

10. The supporting spacer according to claim 9, wherein the vertical plate (212) has a platform (214) formed in a lateral side of the step section (213.)
